(19) United States
(12) Patent Application Publication
(10) Pub. No.: US 2026/0321608 A1
(43) Pub. Date: Oct. 15, 2026

(54) BATTERY ELECTRODE AND MANUFACTURING METHOD THEREOF

(71) Applicant: DAVID TIEN-WEI HSU, Victoria BC (CA)

(72) Inventor: Daniel Lin, Taoyuan City (TW)

(73) Assignee: DAVID TIEN-WEI HSU, Victoria BC (CA)

(21) Appl. No.: 18/878,873

(22) PCT Filed: Dec. 8, 2023
(86) PCT No.: PCT/CA2023/051630

§ 371 Date: Dec. 24, 2024

(51) Int. Cl. H01M 4/38; H01M 4/02; H01M 4/04; H01M 4/36

(52) U.S. Cl. CPC H01M 4/386; H01M 4/0421; H01M 4/366; H01M 2004/021

(57) ABSTRACT

A battery electrode including a conductive substrate, a silicon film, and a silicon fiber layer is provided. The silicon fiber layer includes a plurality of silicon fibers, and each silicon fiber has a section with an inconsistent width.

### TECHNICAL FIELD

The present invention relates to an electrode and a manufacturing method thereof, and in particular to a battery electrode and a manufacturing method thereof.

### RELATED ART

In recent years, the application of recyclable batteries (such as rechargeable lithium batteries) has become more and more widespread. How to increase the capacitance and/or the service life of the battery is indeed a research topic.

### SUMMARY OF INVENTION

The present invention provides a battery electrode that can increase the capacitance and/or the service life of the battery.

The battery electrode of the present invention includes a conductive substrate, a silicon film, and a silicon fiber layer. The silicon fiber layer includes multiple first silicon fibers, and each first silicon fiber has a second section with an inconsistent width.

In an embodiment of the present invention, each first silicon fiber further has a first section with a consistent width, the first section is connected to the silicon film, and the second section is connected to the first section.

In an embodiment of the present invention, the silicon film has an oxidation zone, and each first silicon fiber extends outward from the oxidation zone.

In an embodiment of the present invention, the thickness of the oxidation zone is 10 μm to 30 μm.

In an embodiment of the present invention, the molar ratio of silicon to oxygen in the oxidation zone is 1:1 to 100:1.

In an embodiment of the present invention, the silicon fiber layer further includes a plurality of second silicon fibers, and tow ends of each second silicon fiber are not in contact with the silicon film.

The manufacturing method of the battery electrode of the present invention includes the following steps: providing a conductive substrate; forming a silicon film on the conductive substrate; and forming a silicon fiber layer on a surface of the silicon film, in which the silicon fiber layer includes multiple first silicon fibers, and each first silicon fiber has a second section with an inconsistent width.

In an embodiment of the present invention, during the process of forming the silicon fiber layer, the silicon concentration in the ambient atmosphere is inconsistent.

In an embodiment of the present invention, the process of forming the silicon fiber layer includes multiple flow cycle steps, and each flow cycle step has a corresponding maximum flow value and a minimum flow value.

In an embodiment of the present invention, the manufacturing method of the battery electrode further includes the following steps: forming an oxidation zone on the surface of the silicon film, and each first silicon fiber extends outward from the oxidation zone.

Based on the above, the surface area of the silicon fiber layer in the battery electrode can be increased through the corresponding silicon fiber. In this way, the contact area between ions (such as lithium ions in the electrolyte) and the battery electrode can be increased, thereby increasing the capacitance and/or the service life of the battery.

### BRIEF DESCRIPTION OF DRAWINGS

FIG. 1A to FIG. 1C are partial cross-sectional schematic views of a manufacturing method of an electrode according to an embodiment of the present invention.

FIG. 2A is a schematic view of air source flow versus time during a manufacturing process of a silicon fiber layer according to an embodiment of the present invention.

FIG. 2B is a schematic cross-sectional view of a single silicon fiber in a silicon fiber layer according to an embodiment of the present invention.

FIG. 3 is a comparison view between [Example] and [Comparative example].

### DESCRIPTION OF EMBODIMENTS

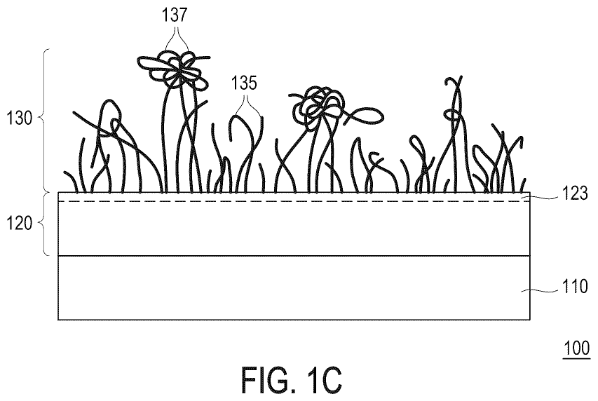

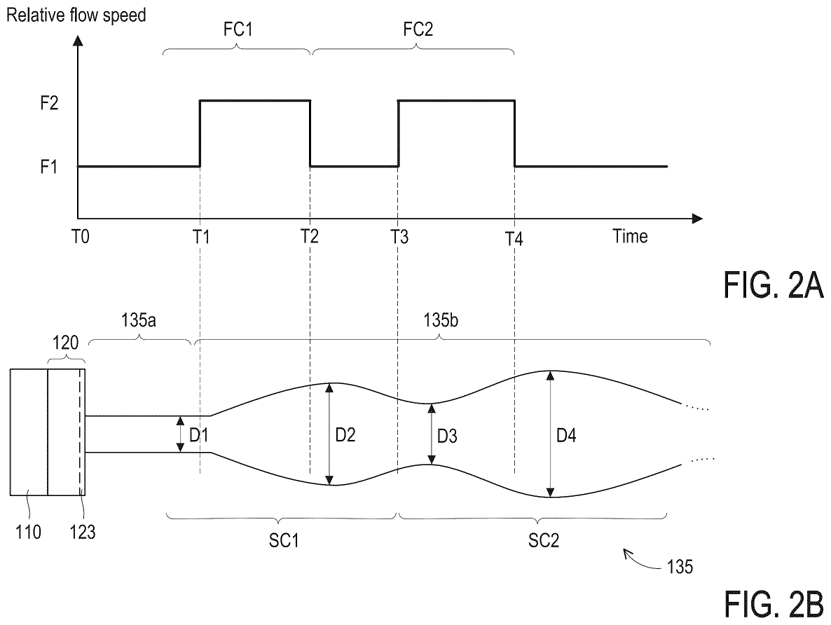

The present invention will be more fully explained below with reference to the drawings of the embodiments. However, the present invention can also be embodied in various forms and should not be limited to the embodiments described herein. The sizes of some layers or regions in the drawings may be exaggerated or reduced for clarity. For example, the cross-sectional size of a single silicon fiber may be exaggerated in FIG. 2B. In addition, the same or similar reference numerals indicate the same or similar elements, and will not be repeated in the following paragraphs.

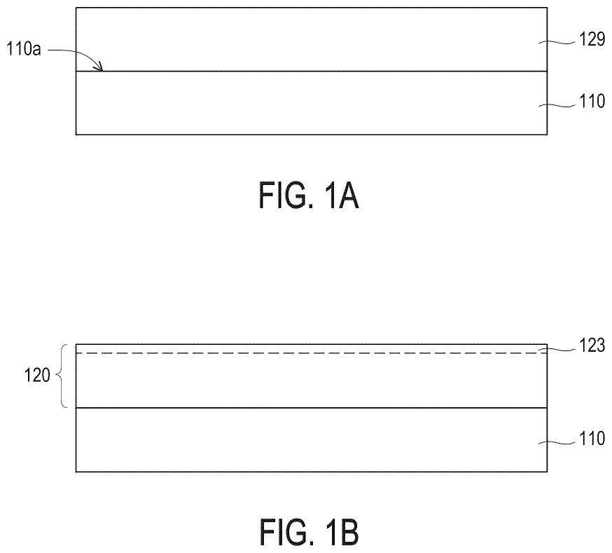

FIG. 1A to FIG. 1C are partial cross-sectional schematic views of a manufacturing method of an electrode according to an embodiment of the present invention. FIG. 2A is a schematic view of air source flow versus time during a manufacturing process of a silicon fiber layer according to an embodiment of the present invention. FIG. 2B is a schematic cross-sectional view of a single silicon fiber in a silicon fiber layer according to an embodiment of the present invention.

Referring to FIG. 1A, a conductive substrate 110 is provided.

The conductive substrate 110 may include block, sheet, or film forms. In an embodiment, the material of the conductive substrate 110 may include copper. For example, the conductive substrate 110 may include a copper block, a copper sheet, or a copper film. For another example, the conductive substrate 110 may include a conductive film (such as a copper film) or a conductive layer (such as a copper layer) formed on a sheet material (such as a steel sheet, an aluminum sheet). That is to say, the conductive substrate 110 is not limited to the form of a single block or a single sheet. That is to say, any substrate with a surface 110a having an appropriate conductivity may be referred to as the conductive substrate 110.

Please continue to refer to FIG. 1A. A silicon film 129 is formed on the surface 110a of the conductive substrate 110. In an embodiment, the silicon film 129 may include amorphous silicon.

In an embodiment, the corresponding silicon film 129 can be formed on the surface 110a of the conductive substrate 110 by deposition methods (such as low-pressure chemical vapor deposition (LPCVD), plasma enhanced chemical vapor deposition (PECVD), but not limited thereto).

In an embodiment, the deposition method for forming the silicon film 129 can, for example, place the conductive substrate 110 in a corresponding chamber and introduce a corresponding silicon source gas (such as Silane, SiH4). In an embodiment, during the deposition process of forming the silicon film 129, a corresponding doping gas (for example, phosphine (PH3) or diborane (B2H6)) may be further introduced so that the formed silicon film 129 can appropriate doping. In an embodiment, the appropriate doping may affect (e.g., improve) electrical properties of the silicon film 129. In an embodiment, the doping gas does not include oxygen.

In an embodiment, at the interface between the conductive substrate 110 and the silicon film 129, metal elements in the conductive substrate 110 may produce a corresponding metal silicon alloy (such as copper silicon alloy) with the silicon film 129, but the present invention is not limited thereto.

Referring to FIG. 1A and FIG. 1B, a silicon film 120 having an oxidation zone 123 is formed.

In an embodiment, after the silicon film 129 is formed, the silicon film 120 having the oxidation zone 123 can be formed by placing the conductive substrate 110 and the silicon film 129 thereon in an atmosphere containing oxygen. It is also worth noting that, for clarity, the silicon film 129 (marked in FIG. 1A) basically not having the oxidation zone (thus not shown or marked) and the silicon film 120 (marked in FIG. 1B) having the oxidation zone 123 are marked with different symbols. Moreover, the difference in appearance and thickness between the silicon film 129 and the silicon film 120 is basically not significant, the difference merely lies in the concentration of oxygen atoms located in an area of the outer surface.

In an embodiment, the process of depositing the silicon film 129 may occur inside the chamber. Moreover, after the silicon film 129 is formed, oxygen can be directly introduced into the chamber to form a silicon film having an oxidation zone.

In an embodiment, the process of depositing the silicon film 129 may occur outside the chamber. Moreover, after the silicon film 129 is formed, the conductive substrate 110 and the silicon film 129 thereon may be placed in a general environment and in contact with oxygen in the atmosphere to form the silicon film 120 having the oxidation zone 123.

In an embodiment, the oxidation zone 123 of the silicon film 120 can hinder the migration of the metal elements (such as copper) in the conductive substrate 110 to a considerable extent (but this does not mean that the metal elements can be completely prevented from the migration). The metal elements may increase the possibility of nucleation during subsequent silicon deposition, thereby reducing the generation of fibrous structures, and/or making the fibrous structures more susceptible to embrittlement or peeling. Therefore, during the process of forming a silicon fiber layer 130 (marked in FIG. 1C) and/or in subsequent processes or applications, through the oxidation zone 123 on the silicon film 120, the possibility of the migration of the metal elements (such as copper) in the conductive substrate 110 to the outer surface the silicon film can be reduced, thereby the quality of the silicon fiber layer 130 can be improved and/or the fabrication of the silicon fiber layer 130 can be made easier.

It is worth noting that in the above steps, the oxidation zone 123 of the silicon film 120 is not limited to completely forming silicon oxide (i.e., forming silicon dioxide). That is to say, the oxidation zone 123 of the silicon film 120 may basically be regarded as a silicon layer with oxygen doping. The thickness of the oxidation zone 123 and/or the concentration of oxygen atoms in the oxidation zone 123 may be adjusted by the corresponding temperature, the oxygen concentration of the environment, and the time of the environment.

In an embodiment, the molar ratio of silicon to oxygen in the oxidation zone 123 may be 1:1 to 100:1. That is to say, the molar concentration of silicon in the oxidation zone 123 may be 1 to 100 times the molar concentration of oxygen. If the ratio of oxygen is too low, then it may reduce the possibility of hindering the migration of the metal elements (such as copper). If the ratio of oxygen is too high, then it may affect the electrical properties (such as increasing resistance).

In an embodiment, the thickness of the oxidation zone 123 may be approximately 10 μm to 30 μm. If the thickness of the oxidation zone 123 is too thin, it may be difficult to effectively reduce the migration of the metal elements (such as copper). If the thickness of the oxidation zone 123 is too thick, then the overall electrical properties may be affected.

In an embodiment, the molar ratio of silicon to oxygen in the oxidation zone 123 may be 1:1 to 100:1, and the thickness of the oxidation zone 123 may be approximately 10 μm to 30 μm.

Referring to FIG. 1B to FIG. 1C, the silicon fiber layer 130 is formed on the oxidation zone 123 of the silicon film 123. It is worth noting that although the silicon fiber layer 130 is described in terms of “layers”, the silicon fiber layer 130 is actually a plurality of silicon fibers (such as a plurality of first silicon fibers 135; or, further including a plurality of second silicon fibers 137), and at least part of the silicon fibers (such as a first silicon fiber 135) extends outward from the oxidation zone 123. In addition, for simplicity, each silicon fiber is directly represented by a thick black line in FIG. 1C. However, it is worth noting that the silicon fibers in FIG. 1C may merely be schematically illustrated, and the length, number, density, and extension direction of the silicon fibers may be adjusted according to corresponding conditions.

In an embodiment, the silicon fiber layer 130 may be formed by a deposition method (such as a low pressure chemical vapor deposition). Since at least part of the silicon fibers (such as the first silicon fiber 135) in the silicon fiber layer 130 are formed on and connected to the silicon film 120, rather than directly formed on the conductive substrate 110, at least the possibility of peeling of the silicon fiber layer 130 can be reduced.

In an embodiment, the deposition method for forming the silicon fiber layer 130 can, for example, place the conductive substrate 110 and the silicon film 120 thereon in a corresponding chamber (such as a furnace tube), and introduce the corresponding silicon source gas. In an embodiment, during the deposition process of forming the silicon fiber layer 130, a corresponding doping gas (for example, phosphine (PH3) or diborane (B2H6)) may be further introduced so that the formed silicon fiber layer 130 can have appropriate doping. In an embodiment, the doping gas does not include oxygen. In an embodiment, during the deposition process of forming the silicon fiber layer 130, other reaction gases may be further introduced; taking hydrogen as an example, the degree of crystallization, deposition rate, and conductivity of the film or layer may be adjusted. In an embodiment, during the deposition process of forming the silicon fiber layer 130, a corresponding buffer gas (such as argon gas) may be further introduced, and the ratio of other gases can be adjusted accordingly.

In an embodiment, the molar ratio of oxygen atoms in the silicon fiber layer 130 is basically smaller than the molar ratio of the oxygen atoms in the oxidation zone 123 of the silicon film 120.

In an embodiment, the molar ratio of a kind of metal atoms in the silicon fiber layer 130 is basically smaller than the molar ratio of the metal atoms in the entire silicon film 120; the metal atoms are included in the conductive substrate 110, such as copper.

In an embodiment, the process of forming the silicon film 120 or the silicon film 129 and the process of forming the silicon fiber layer 130 may use the same chamber, but the present invention is not limited thereto.

In an embodiment, the process conditions for forming the silicon film 129 and the process conditions for forming the silicon fiber layer 130 may be similar, and the difference lies in the process recipe.

In an embodiment, during the process of forming the silicon fiber layer 130, the corresponding gas pressure may be greater than or equal to approximately 300 mtorr and less than or equal to approximately 900 mtorr; preferably, it may be greater than or equal to approximately 500 mtorr and less than or equal to approximately 800 mtorr.

In an embodiment, during the process of forming the silicon fiber layer 130, the corresponding temperature may be greater than or equal to approximately 400° C. and less than a heat-resistant temperature of the corresponding device or element; preferably, it may be greater than or equal to about 480° C. and less than or equal to approximately 600° C.

In an embodiment, during the process of forming the silicon fiber layer 130, the gas ratio (such as the partial pressure ratio; which can be converted by the corresponding flow rate) of the silicon source gas (such as silicon methane) in the chamber may be approximately 5% to 50%.

In an embodiment, in the initial process of forming the silicon fiber layer 130, the silicon source gas can have a corresponding flow rate, which is suitable for forming the corresponding silicon fiber (such as the first silicon fiber 135), thereby reducing the possibility of nucleation or film formation.

Please refer to FIG. 2A together with FIG. 2B. In the initial process of forming the silicon fiber layer 130, the silicon source gas has a corresponding flow value F1, so that the silicon fiber 135 can be formed and extends outward from the oxidation zone 123.

In an embodiment, during at least part of the process of forming the silicon fiber layer 130, the flow rate of the silicon source gas may not be maintained at a corresponding fixed value, but may be cyclically adjusted between a low flow rate and a high flow rate within an appropriate range. In this way, part of the formed silicon fibers (such as the first silicon fiber 135) can have an inconsistent diameter width, thereby increasing the surface area of the silicon fiber layer 130.

Taking FIG. 2A as an example, there may be multiple flow cycles (at least two flow cycles FC1 and FC2 are schematically illustrated in FIG. 2A) during the at least part of the process of forming the silicon fiber layer 130, each flow cycle has a corresponding silicon source gas maximum flow value (hereinafter referred to as: maximum flow value) and a silicon source gas minimum flow value (hereinafter referred to as: minimum flow value). Under the same unit, the maximum flow value is at least 2 to 5 times the minimum flow value.

Please refer to FIG. 2A together with FIG. 2B. By the method described in FIG. 2A, the silicon fiber can be made to have multiple structure cycles corresponding to as shown in FIG. 2B (at least two structure cycles SC1, SC2 are schematically shown in FIG. 2A), each structure cycle has a corresponding maximum width value and a minimum width value. However, it is worth noting that in FIG. 2B, the silicon fiber 135 shown is merely schematically shown for clear and simple explanation. For example, in FIG. 2B, the silicon fiber 135 is shown extending in a specific direction, but the actual silicon fiber 135 may appear in a corresponding curve or curl shape. That is to say, substantially, the extending direction of the silicon fiber 135 may not be fixed, but is generally in a direction away from the silicon film 120.

In the process of forming silicon fibers, an increase in the flow rate of the silicon source gas can increase the silicon concentration in the ambient atmosphere, and correspondingly make the silicon fibers have a larger width; moreover, a decrease in the flow rate of the silicon source gas can reduce the silicon concentration in the ambient atmosphere, and correspondingly make the silicon fiber have a smaller width. Taking FIG. 2A and FIG. 2B as an example, the structure cycle SC1 may correspond to the flow cycle FC1, and the structure cycle SC2 may correspond to the flow cycle FC2. However, it is worth noting that during the deposition process, due to the need to consider the gas atmosphere (such as concentration changes or gas distribution) and/or the reaction rate in the chamber, in each corresponding flow cycle FC1, FC2 and structure cycle SC1, SC2, the maximum flow value may not directly correspond to the maximum width, and the minimum flow value may not directly correspond to the minimum width. Further taking FIG. 2A and FIG. 2B as an example, in the first flow cycle FC1, the silicon source gas flow rate can rise sharply from the minimum flow value F1 to a maximum flow value F2 at a time T1, and the corresponding structure can increase continuously and gradually from a small width D1 after the time T1. Still taking FIG. 2A and FIG. 2B as an example, between the first flow cycle FC1 and the second flow cycle FC2, the silicon source gas flow rate can drop sharply from the maximum flow value F2 to the minimum flow value F1 at a time T2, and the width of the corresponding structure may still increase slightly to a large width D2 after the time T2 possibly due to a delay in the deposition process; then, the width decreases continuously and gradually. Still taking FIG. 2A and FIG. 2B as an example again, in the second flow cycle FC2, the silicon source gas flow rate can rise sharply from the minimum flow value F1 to the maximum flow value F2 at a time T3, and the width of the corresponding structure may still decrease slightly to a small width D3 after the time T3 possibly due to a delay in the deposition process; then, the width increases continuously and gradually.

It is worth noting that although in each flow cycle (such as the flow cycles FC1, FC2), the corresponding minimum flow value (such as the minimum flow value F1) and the corresponding maximum flow value (such as the maximum flow value F2) may be respectively identical or similar to each other, in the corresponding structure cycle, the corresponding minimum width value and maximum width value may still be slightly different. Taking FIG. 2A and FIG. 2B as an example, the width D1 may not be equal to the width D3; and/or, the width D2 may not be equal to a width D4.

In an embodiment, the width D2 may be approximately greater than 1 time and less than or equal to approximately 4 times of the width D1; and/or the width D4 may be approximately greater than 1 time and less than or equal to approximately 10 times of the width D3.

In an embodiment, the average width of the silicon fiber 135 within a range may gradually increase as moving away from the silicon film 120. For example, the structure cycle SC2 is further away from the silicon film 120 than the structure cycle SC1, and the average width within the range of the structure cycle SC2 may be greater than the average width within the range of the structure cycle SC1. The average width may be estimated, for example, by dividing the sampling cross-sectional area by the sampling distance. For another example, the minimum width (e.g., the width D3) within the range of the structure cycle SC2 may be greater than the minimum width (e.g., the width D1) within the range of the structure cycle SC1; and/or, the maximum width (e.g., the width D4) within the range of the structure cycle SC2 may be greater than the maximum width (e.g., the width D2) within the range of the structure cycle SC1.

In an embodiment, during the process of forming terminal ends of the silicon fiber layer 130, some silicon fibers 137 that are not connected to the silicon film 120 may be formed.

Please refer to FIG. 1C together with FIG. 2B. In terms of structure, an electrode 100 may include the conductive substrate 110, the silicon film 120, and the silicon fiber layer 130. The silicon film 120 is positioned on the conductive substrate 110. The silicon fiber layer 130 is positioned on the silicon film 120. The silicon fiber layer 130 comprises multiple silicon fibers.

In an embodiment, the silicon film 120 may have the oxidation zone. Part of the silicon fiber in the silicon fiber layer 130 extends outward from the oxidation zone of the silicon film 120.

In an embodiment, the silicon fiber includes the first silicon fiber 135. The first silicon fiber 135 extends outward from the oxidation zone 123 of the silicon film 120. The first silicon fiber 135 has a first section 135a and a second section 135b. The first section 135a is connected to the oxidation zone 123 of the silicon film 120. The second section 135b is connected to the first section 135a. The width of the first section 135a is basically consistent. The width of the second section 135b is basically inconsistent.

In an embodiment, the silicon fiber may further include a second silicon fiber 137. Basically, two ends of the second silicon fiber 137 are not connected to the oxidation zone 123 of the silicon film 120. The second silicon fiber 137 may be wound around or embedded in the ends of the plurality of first silicon fibers 135 (i.e., the other end of the first silicon fiber 135 opposite to the end connecting the oxidation zone 123); even, the second silicon fiber 137 may be connected to the first silicon fiber 135 and have a form similar to a spherical or granular shape at the terminal end.

The electrode 100 in this embodiment may be applied to the battery (such as the lithium battery). Through the corresponding silicon fiber (such as the silicon fiber 135), the surface area of the silicon fiber layer 130 can be increased. In this way, the contact area between ions (such as lithium ions in the electrolyte) and the electrode 100 can be increased, thereby increasing the capacitance and/or the service life of the battery.

### EXAMPLE AND COMPARABLE EXAMPLE

[Example] and [Comparative example] are shown below to specifically describe the present invention, but the present invention is not limited at all by the following examples.

[Example] and [Comparative example] basically use the same method to make the lithium batteries and the same method for testing. The difference is merely that, in the electrode in [Example], the silicon fiber layer adopts the structure of the embodiment the same or similar to as shown in FIG. 1C and FIG. 2B); in the electrode in [Comparative example], the silicon fiber in the silicon fiber layer basically has a consistent width (approximately the same as the initial width of the silicon fiber in [Example]).

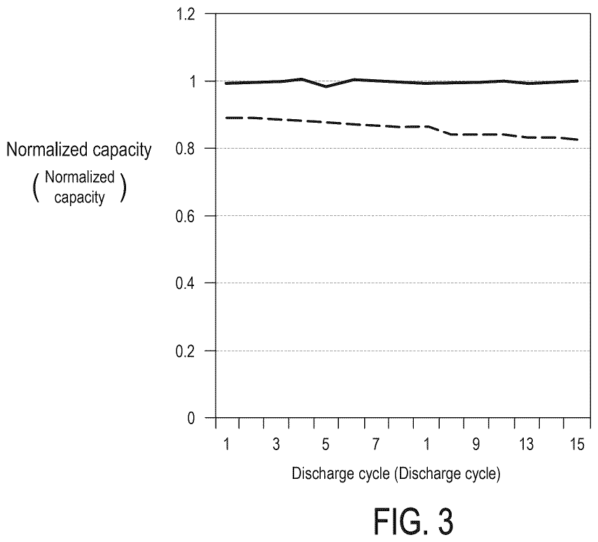

FIG. 3 is a comparison view between [Example] and [Comparative example], in which the horizontal axis is the corresponding discharge cycle, and the vertical axis is the effective charging capacity that can be performed after each discharge cycle. Furthermore, the initial effective charging capacity value in [Example] is set to 1 for the normalized comparison.

As shown in FIG. 3, compared to [Comparative example], the battery in [Example] can have a higher effective capacitance. Moreover, after multiple discharge cycles, the attenuation amplitude or rate of the effective capacitance of the battery in [Example] is less than the battery in [Comparative example], so the battery in [Example] can have a longer service life.

In summary, the electrode of the present invention can be applied to batteries (such as lithium batteries). Moreover, through the corresponding silicon fiber, the surface area of the silicon fiber layer in the electrode can be increased. In this way, the contact area between ions (such as lithium ions in the electrolyte) and the electrode can be increased, thereby increasing the capacitance and/or the service life of the battery.

### REFERENCE SIGNS LIST

100: electrode
110: conductive substrate
110a: surface
120, 129: silicon film
123: oxidation zone
130: silicon fiber layer
135: first silicon fiber
135a: first section
135b: second section
137: second silicon fiber
D1, D2, D3, D4: width
F1, F2: flow value
FC1, FC2: flow cycle
SC1, SC2: structure cycle
T0, T1, T2, T3, T4: time

What is claimed is:

1. A battery electrode, comprising:
a conductive substrate;
a silicon film; and
a silicon fiber layer comprising a plurality of first silicon fibers, and each of the first silicon fibers has a second section with an inconsistent width.

2. The battery electrode as claimed in claim 1, wherein each of the first silicon fibers has a first section with a consistent width, the first section is connected to the silicon film, and the second section is connected to the first section.

3. The battery electrode as claimed in claim 1, wherein the silicon film has an oxidation zone, and each of the first silicon fibers extends outward from the oxidation zone.

4. The battery electrode according to claim 3, wherein a thickness of the oxidation zone is 10 μm to 30 μm.

5. The battery electrode according to claim 3, wherein a molar ratio of silicon to oxygen in the oxidation zone is 1:1 to 100:1.

6. The battery electrode as claimed in claim 1, wherein the silicon fiber layer further comprises a plurality of second silicon fibers, and two ends of each of the second silicon fibers are not in contact with the silicon film.

7. A manufacturing method of a battery electrode, comprising:
providing a conductive substrate;
forming a silicon film on the conductive substrate; and
forming a silicon fiber layer on a surface of the silicon film, wherein the silicon fiber layer comprises a plurality of first silicon fibers, and each of the first silicon fibers has a second section with an inconsistent width.

8. The manufacturing method of the battery electrode as claimed in claim 7, wherein during a process of forming the silicon fiber layer, a silicon concentration in an ambient atmosphere is inconsistent.

9. The manufacturing method of the battery electrode as claimed in claim 8, wherein the process of forming the silicon fiber layer comprises a plurality of flow cycle steps, and each of the flow cycle steps has a corresponding maximum flow value and a minimum flow value.

10. The manufacturing method of the battery electrode as claimed in claim 7, comprising:
forming an oxidation zone on the surface of the silicon film, and each of the first silicon fibers extends outward from the oxidation zone.
